(19) United States
(12) Patent Application Publication
(10) Pub. No.: US 2003/0129356 A1
(43) Pub. Date: Jul. 10, 2003

(54) Insulation material

(76) Inventor: Victor P. Laskorski, N. Attleborough, MA (US)

Correspondence Address: FROMMER LAWRENCE & HAUG, 745 FIFTH AVENUE- 10TH FL., NEW YORK, NY, 10151, US

(21) Appl. No.: 10/039,511

(22) Filed: Jan. 4, 2002

(51) Int. Cl. B32B 3/06

(52) U.S. Cl. 428/102

(57) ABSTRACT

An insulation material made from a plurality of layers of material having inserts being inserted therebetween with the layers being bound together maintaining the inserts in place with the inserts being taken from a variety of materials and of a variety of shapes.

### FIELD OF THE INVENTION

The present invention is directed towards an insulation material, particularly such material for use in sleeping bags and other similar items.

### BACKGROUND OF THE INVENTION

There presently exists insulation material which is made from a non-woven batt of material. The batt is made up of random fibers which may be natural or synthetic, or a mixture of each. The batt typically includes thermoplastic fibers which are mixed therein which are heatset so as to create a cohesive structure.

While such material typically provides for the desired insulation ability, it often lacks the characteristic of loft. To address this, U.S. Pat. No. 5,798,166 teaches the use of a batt having raised structures thereon. This allows for an increase of loft as to the overall material without proportionally increasing the density of the material. While the insulation material set forth in the aforesaid patent has provided for increased loft, among other things, it is desirable to further improve upon such material.

### SUMMARY OF THE INVENTION

It is a principal object of the invention to provide for an insulation material which has improved loft without a proportional increase in density.

It is a further object of the invention to provide for an insulation material which has improved insulating characteristics without an increase in weight.

A yet further object of the invention is to provide for an insulation material which is lightweight and foldable or rollable like that used in sleeping bags.

It is a further object of the invention to allow for a change in the material's compressibility, weight, comfort, water absorption and other properties.

These and other objects and advantages are provided by the present invention. In this regard the present invention provides for an insulation material which may be made from macro fibers and micro fibers of the type as set forth in U.S. Pat. No. 4,992,327 the disclosure of which is incorporated herein by reference. The batt is rendered cohesive by heatsetting.

The present invention provides for at least two layers of non-woven insulation material or batt having sandwiched therebetween a plurality of elements. The inserts could be shaped strips, rope, flexible tubes, foam, fiberglass, fibrous sliver/tow, helices of fiber or filaments or other material suitable for the purpose. The inserts should be flexible to allow the material to be rolled up or folded as in the case when used in sleeping bags or similar articles. The type and weight of the material, its density, softness and water absorption abilities can be selected so as to vary its properties.

The insulation material can be fabricated in the following way. A first layer of non-woven material or batt is typically formed containing some thermoplastic or low melt binder fibers (e.g. polyester) and other fibers by carding, for example. The material can be, if necessary, partially heatset to form a cohesive unit. The particular inserts (or mixture of inserts) can then be placed on the first layer in a desired pattern, including being stacked or otherwise arranged, with a second layer of material placed thereover. This second layer may also contain thermoplastic fibers. The second layer will tend to sink or settle down onto the first layer in areas where the inserts are absent. The entire structure can then be bound together by being heatset in an oven (or thermo bonded, e.g. infrared, hot air, etc.), glued, stitched, needled or by way of other means suitable for the purpose, to bind the two layers together with the inserts maintained therewithin. The inserts may be such that they become fixed in place without even having to adhere them to the layers of batt. The inserts add an amount of openness to the structure and, depending upon the makeup of the inserts, can add to its compressibility, resiliency, absorption or other properties.

### BRIEF DESCRIPTION OF THE DRAWINGS

Thus by the present invention, its objects and advantages will be realized the description of which should be taken in conjunction with the drawings, wherein:

FIG. 1 is a perspective view of an insulation material comprising two layers of material with inserts therebetween, incorporating the teachings of the present invention;

FIG. 2 is a perspective view of an insulation material having stacked inserts between two layers of material, incorporating the teachings of the present invention;

FIG. 3 is a perspective view of helically formed inserts between two layers of material, incorporating the teachings of the present invention;

FIG. 4 is a perspective view of helically formed inserts in a stacked relationship with intermediate layers of material, incorporating the teachings of the present invention; and

FIGS. 5A-5C show perspective views of the helically formed or coiled inserts taken at different angular views, incorporating the teachings of the present invention.

### DETAILED DESCRIPTION OF THE PREFERRED EMBODIMENT

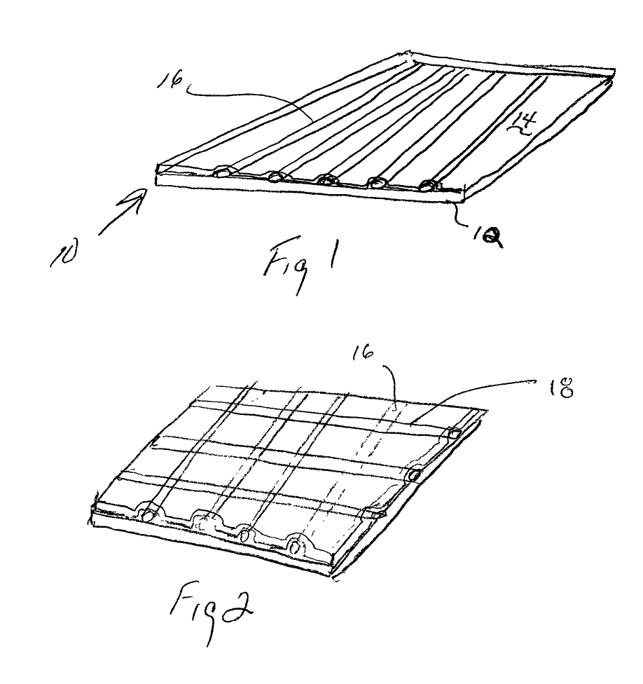

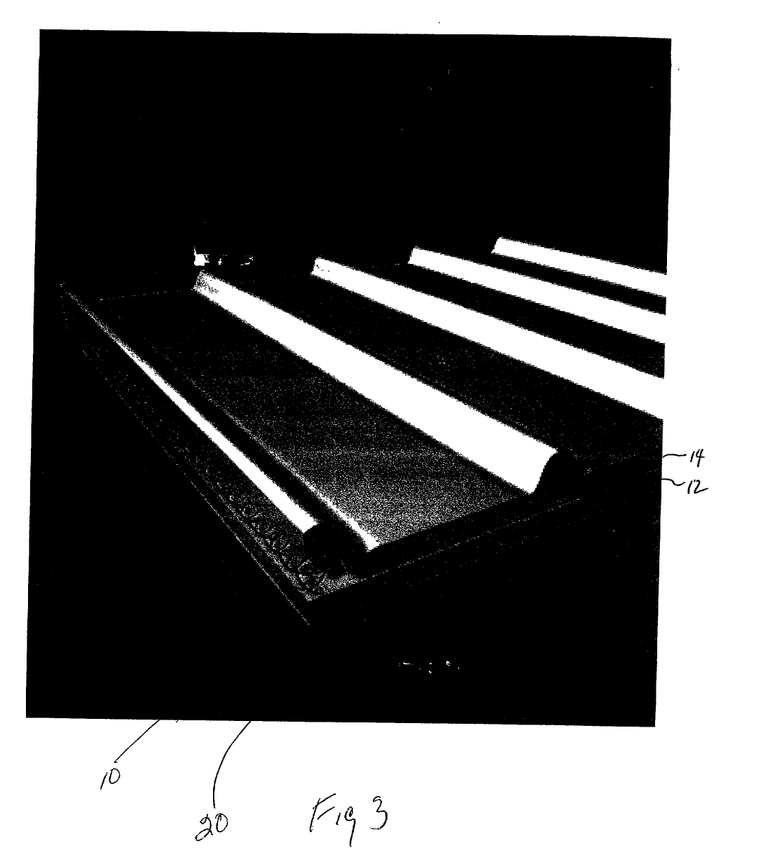

Turning now more particularly to the drawings, where like parts are similarly numbered, the present invention is directed towards an insulation structure or unit 10 shown generally in FIG. 1. As will be seen, unit 10 comprises a first or bottom layer non-woven material or batt 12. The layer 12 may comprise a mixture of synthetic and natural fibers. Preferably, the layer 12 is formed in a manner set forth in U.S. Pat. No. 4,992,327 which is a mixture of synthetic micro fibers and macro fibers in a preferred percentage for enhanced thermal insulating properties. The fibers making up the layer 12 are bonded at some contact points therebetween. This can be accomplished by way of, for example, having certain fibers which are coated with a thermoplastic material or, by including binder fibers to the mixture and heatsetting (at least partially) the same to create a cohesive structure.

A second layer of material 14 may be similarly formed.

Interposed between the two layers 12 and 14 are positioned inserts 16 which may be laid out in any pattern desired. These inserts 16 may take the form of shaped strips of material (fibrous or non-fibrous), ropes, flexible thin wall tubing, foam material, fiberglass, fibrous sliver/tow, helix of fiber or filaments, or any other material suitable for the purpose. The inserts 16 should be flexible enough to allow the insulation material to be rolled or folded as in the case when the intended use is in a sleeping bag or comforter.

The insulation unit 10 can be assembled in a somewhat simplified process. A first layer of material 12 may be formed by carding, for example. It should be noted, however, that other non-woven insulation layers are envisioned, such as those that may be formed by other methods. For example, the layers may comprise air laid fibers, melt blown fibers, spun-bond fibers, hydro-entangled fibers or any other type construction suitable for the purpose. Also, the layer or layers may be a combination of layers of materials formed in various ways creating a composite of layers of material which are selected depending upon the particular application.

Once the first layer 12 is formed and laid out, the inserts 16 are then placed thereon in the desired pattern, i.e. parallel, skewed, etc. with the second layer 14 being placed thereover. The resulting structure can then be heatset to bind the two layers together with the inserts being maintained therebetween. The inserts 16 may themselves incorporate a binder agent so as to bind them also to the first and second layer, if so desired. Otherwise the binding of the two layers 12 and 14 should secure the inserts 16 in place without the need to bind them separately thereto. While the use of thermoplastic coatings or binder fibers in the binding process is preferred, as aforenoted, there are other means of securing the layers together that might be equally appropriate.

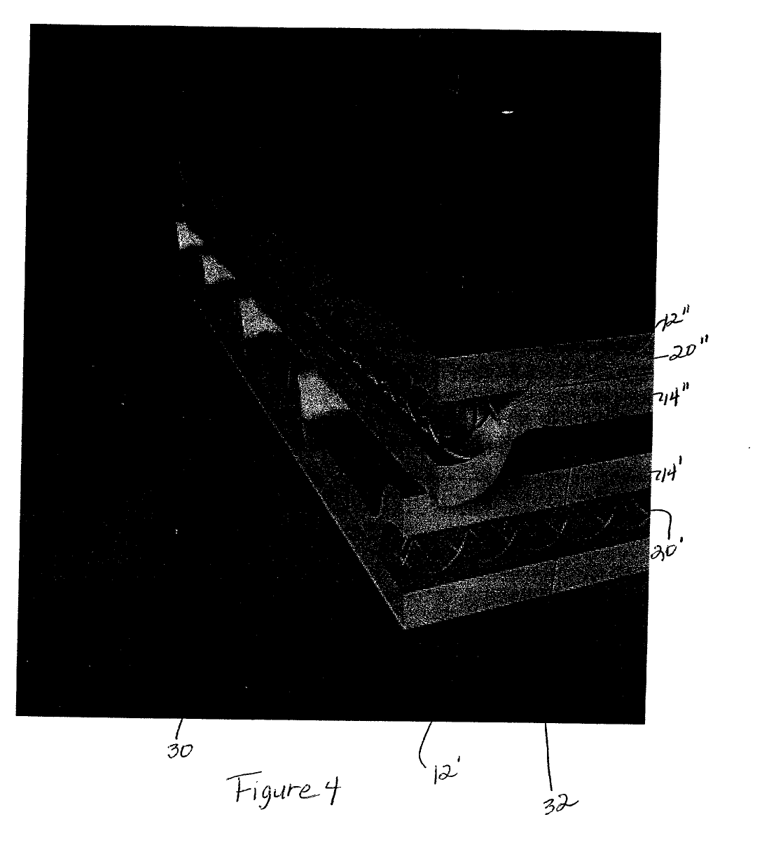

Turning now to FIG. 2, the comments with regard to FIG. 1 equally apply. The difference is that additional inserts 18 are provided which are stacked upon and transverse to inserts 16. The pattern shown is merely illustrative and other patterns, which include those incorporating a mixture of different types of inserts.

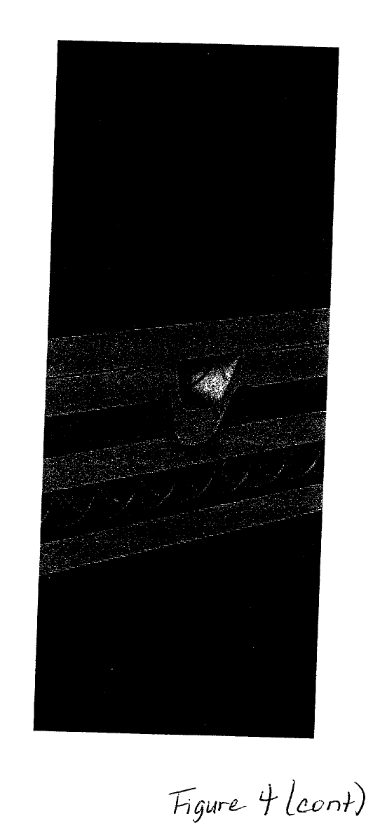

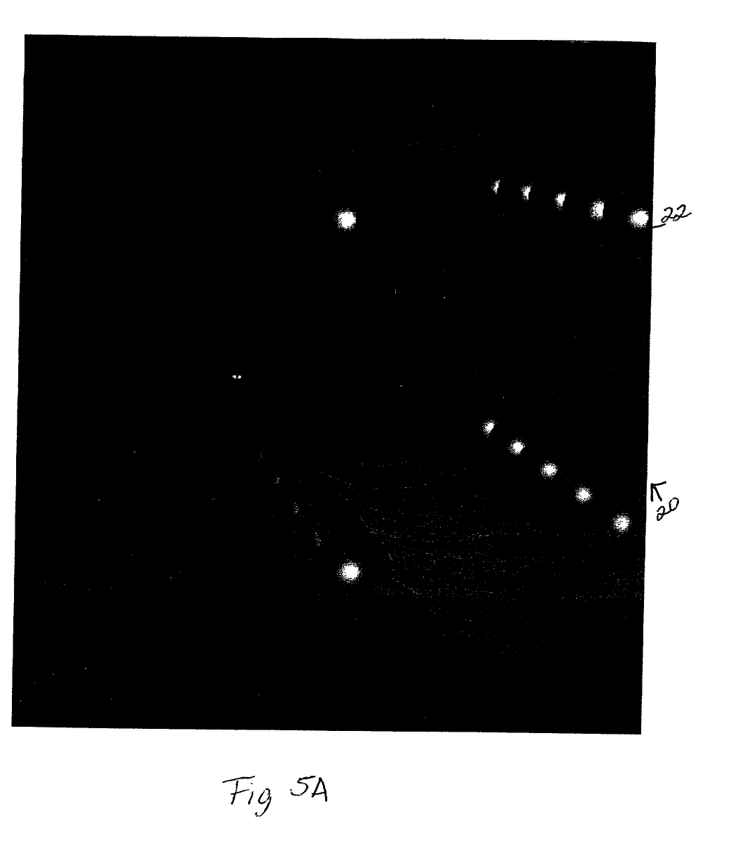

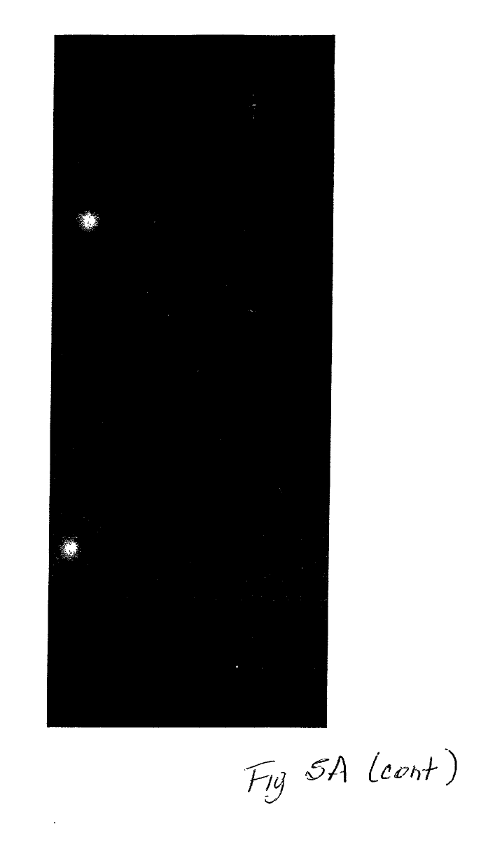

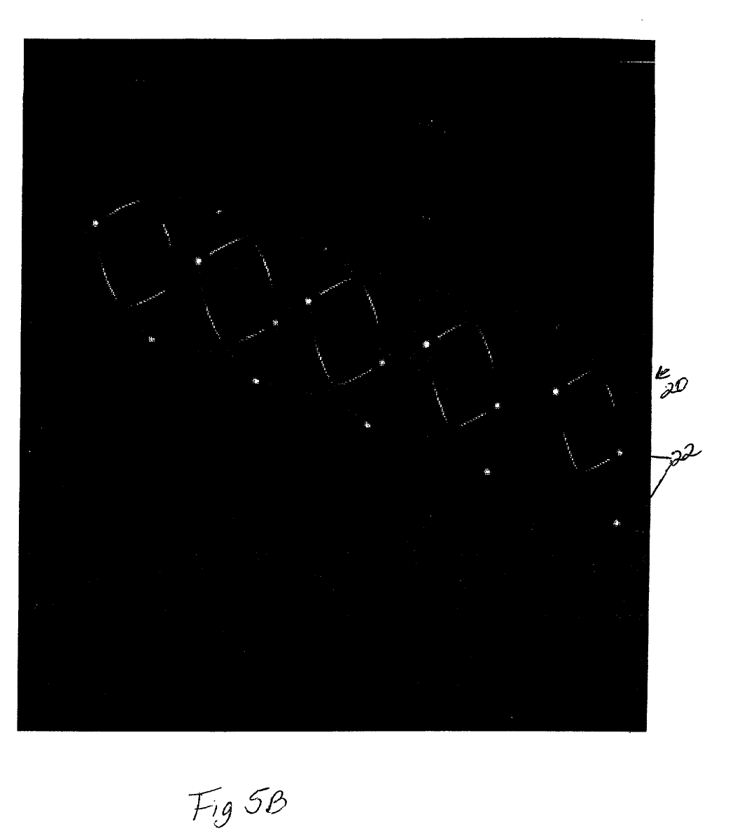

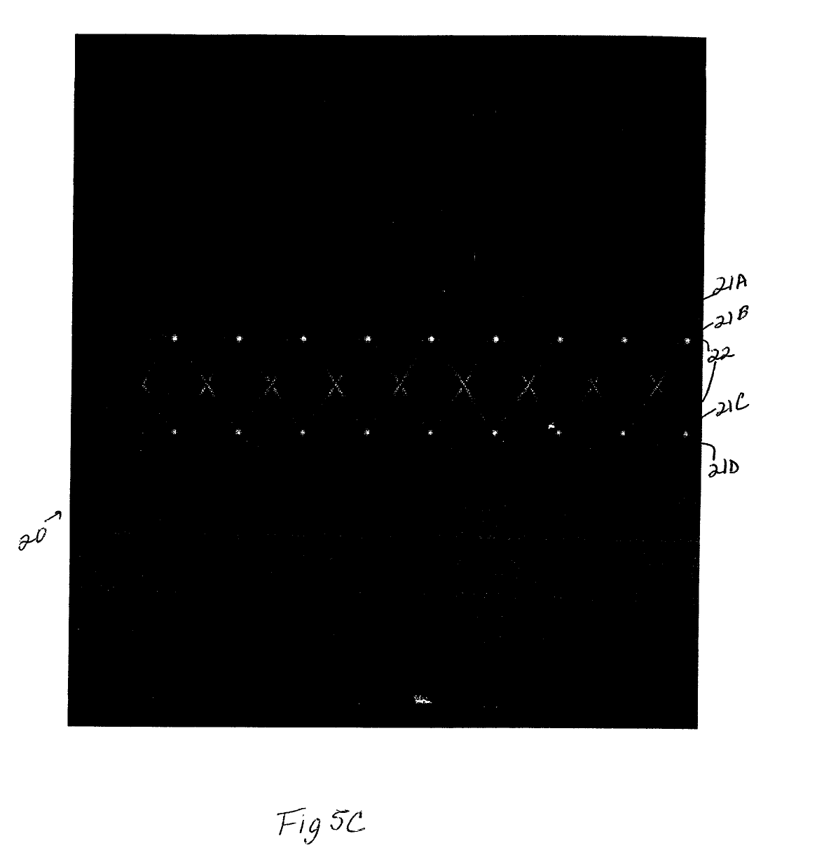

Turning now to FIGS. 3 and 4, further embodiments of the present invention are shown. In this regard, the insert material may comprise a helix 20 of fiber or filament. These helices 20 may take on a variety of forms. FIGS. 5A-5C illustrate one such form. In this regard, helix 20 is formed, for example, from four strands of coiled fiber 21A, 21B, 21C and 21D which are bonded at contact or crossover points 22. Other helical type structures suitable for the purpose should be apparent to those skilled in the art. The fiber making up the helices, when bonded at the points 22, forms a somewhat rigid tubular structure. Due to the relative openness of the structure, its weight would be low, with the circular cross section providing good compressibility and resilience. The diameter, number of filaments and angle of the helix 20 will affect this.

As shown in FIG. 3, the helices 20 are sandwiched between two layers of material 12 and 14 to make up the insulation unit 10. The layers 12 and 14 can be bonded or glued together as aforesaid discussed. Note that the deflection of the insulation unit 10, including that of the helix 20, would be allowed by the skew of the filaments that would occur due to deflection around the open areas of the helix 20, in addition to that of the compressibility of the material used generally in the insulation unit 10.

With regard to FIG. 4, this shows a stacked version of the insulation unit 10′. In this regard, it comprises a first or bottom layer 12′ of material, a first layer of insertions in the form of helices 20′, a second intermediate layer of material 14′, a third intermediate layer of material 14″, a second layer of inserts in the form of helices 20″ which are in the direction transverse to the first layer of helices 20′, and a fourth or top layer of material 12″. As can be seen, the insulation unit 10′ is illustrated as being two of the insulation unit 10 shown in FIG. 3 with the upper one flipped over, stacked on top and rotated 90° with respect to the bottom one and bonded, glued or otherwise joined together in a manner as aforedescribed. Such a stacked arrangement creates significant void pockets at the interface of the two insulation units 10. Note that to maximize the voids within the insulation unit 10′, it may be desirable to heatset or partially heatset the two insulation units 10 prior to combining them together. This will provide a certain amount of relative rigidity between, for example, layers 14′ and 14″ so that the layers parts do not settle down and fill the voids such as those at areas 30 and 32 located between layers 14′ and 14″.

Thus by the present invention its objects and advantages are realized, and although preferred embodiments have been disclosed and described in detail herein, its scope and objects should not be limited thereby; rather is scope should be determined by that of the appended claims.

What is claimed is:

1. An insulation material comprising:
a first layer of material of somewhat uniform thickness;
a second layer of material of somewhat uniform thickness for positioning over said first fabric;
inserts for insertion between said first layer and said second layer; and
means for affixing said first layer and said second layer together whilst securing the inserts therebetween.

2. The insulation material in accordance with claim 1 wherein said means for affixing includes thermo bonding, thermo setting, gluing, stitching or needling.

3. The insulation material in accordance with claim 2 wherein said inserts are taken from the group consisting essentially of: strips of material which is fibrous or non-fibrous, rope, flexible thin wall tubing, foam material, fiberglass, fibrous sliver/tow or material formed into a helix.

4. The insulation material in accordance with claim 1 wherein said inserts are taken from the group consisting essentially of: strips of material which are fibrous or non-fibrous, rope, flexible thin wall tubing, foam material, fiberglass, fibrous sliver/tow or material formed into a helix.

5. The insulation material in accordance with claim 1 which includes two layers of inserts.

6. The insulation material in accordance with claim 5 wherein at least some of inserts of one layer are at an angle to inserts in a second layer.

7. The insulation material in accordance with claim 6 wherein the angle is 90°.

8. The insulation material in accordance with claim 5 which includes at least one intermediate layer of material of somewhat uniform thickness disposed between the two layers of inserts.

9. The insulation material in accordance with claim 6 which includes at least one intermediate layer of material of somewhat uniform thickness disposed between the two layers of inserts.

10. The insulation material in accordance with claim 5 which includes at least two intermediate layers of material of somewhat uniform thickness disposed between the two layers of inserts.

11. The insulation material in accordance with claim 1, wherein said layers of material are non-woven and comprise: batt, air laid fibers, melt blown fibers, spun-bond fibers or hydro-entangled fibers.

12. The insulation material in accordance with claim 8, wherein said layers of material are non-woven and comprise: batt, air laid fibers, melt blown fibers, spun-bond fibers or hydro-entangled fibers.

13. The insulation material in accordance with claim 9, wherein said layers of material are non-woven and comprise: batt, air laid fibers, melt blown fibers, spun-bond fibers or hydro-entangled fibers.

14. The insulation material in accordance with claim 10, wherein said layers of material are non-woven and comprise: batt, air laid fibers, melt blown fibers, spun-bond fibers or hydro-entangled fibers.
